(19) United States
(12) Patent Application Publication
(10) Pub. No.: US 2019/0008155 A1
(43) Pub. Date: Jan. 10, 2019

(54) Synergistic Agricultural Formula Comprising Diacyl or Diaryl Urea and At Least One Plant Growth Regulator

(71) Applicant: Stoller Enterprises, Inc., Houston, TX (US)

(72) Inventors: Ritesh Bharat Sheth, Friendswood, TX (US); Jerry Herman Stoller, Houston, TX (US); Robert Richard Shortell, Houston, TX (US)

(73) Assignee: Stoller Enterprises, Inc., Houston, TX (US)

(21) Appl. No.: 16/027,997

(22) Filed: Jul. 5, 2018

Related U.S. Application Data
(60) Provisional application No. 62/529,044, filed on Jul. 6, 2017.

(51) Int. Cl. A01N 47/28; A01N 45/00; A01N 43/54; A01N 43/38

(52) U.S. Cl. CPC A01N 47/28; A01N 43/38; A01N 43/54; A01N 45/00

(57) ABSTRACT

A synergistic agricultural formula including at least one diacyl or diaryl urea, such as a N,N′-diformylurea, and at least one plant growth regulator. This synergistic agricultural formula gives those skilled in the art the ability to regulate important phenotypical parameters that lead to a variety of important agronomic and horticulture traits which improve crop yield parameters leading beyond that of its individual components.

### CROSS REFERENCE TO RELATED APPLICATION

This application claims the benefit, under 35 U.S.C. 119(e), of U.S. Provisional Patent Application No. 62/529,044 filed Jul. 6, 2017, the contents of which are incorporated herein by reference.

### BACKGROUND OF THE INVENTION

### 1. Field of the Invention

The present invention generally relates to a synergistic agricultural formula including at least one diacyl or diaryl urea and at least one plant growth regulator (PGR) to produce a highly pronounced increase in plant growth, development and yield in plant cells and whole plant culture.

### 2. Description of the Background

As provided in International Publication No. WO 2012068473, the contents of which are expressly incorporated herein by reference, plant growth and development as well as productivity (e.g., crops, seeds, fruits etc.) are known to be regulated by growth factors, mineral components and small molecules that signal for the expression of genes that enhance the level of plant productivity, whether in quantity or quality. Traditional approaches for improving plant productivity have included the application of various minerals and nitrogen components as necessary additions or substrates to crop plant or other plant productivity. However, such approaches have tended to knowingly, or unknowingly, disregard the growth factors (e.g., phytohormones and/or other small molecules) required for enhanced productivity.

Traditionally, mineral fertilizers have been predominately applied to growing crop plants. Difficulties arise, however, when external stresses impede successful plant development, especially of grain or seed crops and/or other crops. Physical stresses, such as those inflicted by environmental temperatures being either too low or too high, and in particular high temperatures, are especially problematic. Moreover, the state-of-the-art agronomic practice does not employ plant growth regulators to overcome a plant's difficulty, due to such stresses, in producing sufficient amounts of nutrients, e.g., sugars, to prevent autophagy (i.e., cannibalization of previously-formed plant cells by newly-forming cells to compensate for a dearth of cell nutrients). It is well known that mineral fertilizers provide eighteen minerals that are necessary for crop growth and development. Signaling molecules, such as plant growth regulators or other molecules, are known to enhance crop productivity through the expression of certain genes. Furthermore, much research has been conducted into the use of plant growth regulators and their effects on plant growth and development.

An alternative, more natural approach, which is becoming ever more appreciated, is based upon the theory that plants already have the necessary genes/genetic code to produce greater quantities and/or qualities of various plant tissues as well as to thrive in the face of common adversities, such as drought, disease, and insect infestations. But, to realize the full expression of this innate genetic material and the plant's full potential, the plant must receive various naturally-occurring nutrients and/or phytohormones in specific concentrations, at specific times during the plant's growth, and to specific parts or tissues of the plant.

As provided in International Publication No. WO 2005/021715, the contents of which are expressly incorporated herein by reference, plant hormones have been known and studied for years. Plant hormones may be assigned to one of a few categories: auxins, cytokinins, gibberellins, abscisic acid, brassinosteroids, jasmonates, salicylic acids, polyamines, peptides, nitric oxides, strigolactones and ethylene. Ethylene has long been associated with fruit ripening and leaf abscission. Abscisic acid causes the formation of winter buds, triggers seed dormancy, controls the opening and closing of stomata and induces leaf senescence. Gibberellins, primarily gibberellic acid, are involved in breaking dormancy in seeds and in the stimulation of cell elongation in stems. Gibberellins are also known to cause dwarf plants to elongate to normal size. Cytokinins, are produced primarily in the roots of plants. Cytokinins stimulate growth of lateral buds lower on the stem, promote cell division and leaf expansion and retard plant aging. Cytokinins also enhance auxin levels by creating new growth from meristematic tissues in which auxins are synthesized. Auxins, promote both cell division and cell elongation, and maintain apical dominance. Auxins also stimulate secondary growth in the vascular cambium, induce the formation of adventitious roots and promote fruit growth.

The most common naturally occurring auxin is indole-3-acetic acid (IAA). However, synthetic auxins, including indole-3-butyric acid (IBA); naphthalene acetic acid (NAA); 2,4-dichlorophenoxy acetic acid (2,4-D); and 2,4,5- trichlorophenoxy acetic acid (2,4, 5-T or Agent Orange) are known. While these are recognized as synthetic auxins, it should be acknowledged that IBA does naturally occur in plant tissues. Many of these synthetic auxins have been employed for decades as herbicides, producing accelerated and exaggerated plant growth followed by plant death. Agent Orange gained widespread recognition when it was used extensively by the United States Army and Air Force in defoliation applications during the Vietnam War. 2, 4-D finds continuing use in a number of commercial herbicides sold for use in agriculture, right of way, and turf and ornamental markets.

N,N′-diformylurea is a proprietary organic molecule that was initially designed to inhibit ethylene production in plants. It functions by quenching the reactive oxygen species signal that causes the conversion of ACC to ethylene. This molecule shows dramatic effects in inhibiting excess cellular ethylene resulting in the maintenance of hormonal balance, plant growth and productivity. Therefore, synergy between management inputs that result in a better response from the same amount of input is highly desirable from both the agronomic and economic points of view.

### SUMMARY OF THE INVENTION

A synergistic agricultural formula including at least one diacyl or diaryl urea, such as a N,N′-diformylurea, and at least one plant growth regulator. The plant growth regulator (PGR) is typically selected from ethylene, auxins, cytokinins, gibberellins, abscisic acid, brassinosteroids, jasmonates, salicylic acids, peptides, polyamines, nitric oxide, strigolactones, precursors, derivatives and mixtures thereof. The synergistic agricultural formula is applied to plants at physiologically sensitive times providing a synergistic interaction of the base components resulting in increased yield and quality of the crop being grown. This synergistic agricultural formula gives those skilled in the art the ability to enhance plant growth and regulate important phenotypical parameters that lead to a variety of important agronomic and horticulture traits which improve crop yield parameters leading beyond that of its individual components. More specifically, this synergistic agricultural formulation can be used to improve plant yield parameters leading to increased yield and quality of economically important crops. These yield parameters include, but are not limited to, root weight, length and architecture, flower, fruit and grain set, stem diameter, tillering/branching and placement, net photosynthesis, plant height and stature, harvestable fruit and grain protein, and sugar and/or starch content leading to increased crop yield and quality and maximum system productivity.

### BRIEF DESCRIPTION OF THE DRAWINGS

The features and advantages of the present invention will become apparent from the following detailed description of a preferred embodiment thereof, taken in conjunction with the accompanying drawings, in which:

FIG. 1 is a graph showing the impact on photosynthesis rate on a plant using a synergistic agricultural formula in accordance with the present invention including 14 wt. % DFU and 10 wt. % of Stollers STIMULATE Yield Enhancer (YE) Plant Growth Regulator Mix applied at a Pint/Acre compared to each individual component applied at a Pint/Acre;

FIG. 2 is a graph showing the impact on transpiration rate on a plant using a synergistic agricultural formula in accordance with the present invention including 14 wt. % DFU and 10 wt. % of Stollers STIMULATE YE Plant Growth Regulator Mix applied at a Pint/Acre compared to each individual component applied at a Pint/Acre.

FIG. 3 is a graph showing the impact on root length on a plant using a synergistic agricultural formula in accordance with the present invention including 14 wt. % DFU and 10 wt. % of Stollers STIMULATE YE Plant Growth Regulator Mix applied at a Pint/Acre compared to each individual component applied at a Pint/Acre;

FIG. 4 is a graph showing the impact on plant biomass of a plant using a synergistic agricultural formula in accordance with the present invention including 14 wt. % DFU and 10 wt. % of Stollers STIMULATE YE Plant Growth Regulator Mix applied at a Pint/Acre compared to each individual component applied at a Pint/Acre;

FIG. 5 is a graph showing the yield upon corn seed treatment using a synergistic agricultural formula in accordance with the present invention including 14 wt. % DFU and 10 wt. % of Stollers STIMULATE YE Plant Growth Regulator Mix applied at a Pint/Acre compared to each individual component applied at a Pint/Acre;

FIG. 6 is a graph showing the yield upon winter wheat seed treatment using a synergistic agricultural formula in accordance with the present invention including 14 wt. % DFU and 10 wt. % of Stollers STIMULATE YE Plant Growth Regulator Mix applied at a Pint/Acre compared to each individual component applied at a Pint/Acre;

FIG. 7 is a graph showing the yield upon soybean seed treatment using a synergistic agricultural formula in accordance with the present invention including 14 wt. % DFU and 10 wt. % of Stollers STIMULATE YE Plant Growth Regulator Mix applied at a Pint/Acre compared to each individual component applied at a Pint/Acre;

FIG. 8 is a graph showing the yield in furrow corn treatment using a synergistic agricultural formula in accordance with the present invention including 7.5 wt. % DFU, 0.01 wt. % cytokinin, and 0.05 wt. % IAA applied at a Pint/Acre compared to each individual component applied at a Pint/Acre; and

FIG. 9 is a graph showing V3-V5 foliar corn treatment using a synergistic agricultural formula in accordance with the present invention including 7.5 wt. % DFU and 0.01 wt. % cytokinin applied at a Pint/Acre compared to each individual component applied at a Pint/Acre.

### DETAILED DESCRIPTION OF THE INVENTION

The present invention is an effective synergistic agricultural formula, preferably an aqueous solution, which comprises, optionally consists essentially of, or optionally consists of, from 30 to 0.1 wt. % of at least one diacyl or diaryl urea, preferably diformylurea, and from 0.001 to 99.9 wt. % of at least one plant growth regulator. In one embodiment, the agricultural formula comprises, optionally consists essentially of, or optionally consists of, from 20-0.1 wt. % of at least one diacyl or diaryl urea, preferably diformylurea, and from 0.001 to 5 wt % of at least one plant growth regulator. In one embodiment, the agricultural formula comprises, optionally consists essentially of, or optionally consists of, from 20-0.1 wt. % of at least one diacyl or diaryl urea, preferably diformylurea, and from 0.001 to 1 wt % of at least one plant growth regulator. In one embodiment, the agricultural formula comprises, optionally consists essentially of, or optionally consists of, from 20-0.1 wt. % of at least one diacyl or diaryl urea, preferably diformylurea, and from 0.001 to 0.05 wt % of at least one plant growth regulator. In one embodiment, the agricultural formula comprises, optionally consists essentially of, or optionally consists of, from 20-1 wt. % of at least one diacyl or diaryl urea, preferably diformylurea, and from 0.001 to 1 wt % of at least one plant growth regulator. In one embodiment, the agricultural formula comprises, optionally consists essentially of, or optionally consists of, from 20-5 wt. % of at least one diacyl or diaryl urea, preferably diformylurea, and from 0.001 to 0.05 wt %, or 0.001 to 0.02 wt. %, of at least one plant growth regulator. In one embodiment, the agricultural formula comprises, optionally consists essentially of, or optionally consists of, from 15-10 wt. % of at least one diacyl or diaryl urea, preferably diformylurea, and from 0.001 to 0.05 wt %, or 0.001 to 0.02 wt %, of at least one plant growth regulator. In the above-identified embodiments, one embodiment provides that no other agriculturally active ingredients are present in said synergistic agricultural formula besides the at least one diacyl or diaryl urea and at least one plant growth regulator.

When diacyl and/or diaryl urea formulations are combined with at least one plant growth regulator, the resulting formulation shows basic and novel biological responses in plants with synergistic effects to either plant growth regulator or diacyl and diaryl urea compounds alone. The resulting synergistic effect of the combined formulation causes a basic and novel maximum response in the yield parameters evaluated at a reduced concentration when compared to the individual components alone. The resulting formulation dramatically increases product efficiency, crop yield, quality and productivity leading to increased profitability at the farm gate while simultaneously reducing the amount of exogenous chemicals needed for agriculture and thus limiting the associated off target risks modern agriculture poses the environment.

The basic and novel characteristics of the present invention are a benefit to crop system management and crop yield in the agriculture and horticultural industries. When applied during germination and establishment this basic and novel characteristic results in an improvement in root and shoot architecture. When applied during the vegetative stage, the basic and novel characteristic includes increased rate of growth and development are observed. When applied at flowering this basic and novel characteristic results in improved fruit or grain set. When applied during fruit sizing and grain fill this basic and novel characteristic results in increased photosynthesis, larger, more marketable fruit, and increased grain fill.

While those skilled in the art will be able to prepare an aqueous solution of the synergistic agricultural formula at desired concentration depending on agricultural uses, it has been found that solutions containing from about 0.001-1.0 M of the active ingredients, i.e diacyl or diaryl urea and plant growth regulators, are beneficial. Aqueous solutions containing from about 0.001-0.050 M are presently preferred for soil and foliar applications. While these solutions may be applied at any rate desired by those of skill in the art, it has been found that aqueous solutions of the foregoing concentration provide optimum results when applied at the rate of about 4-16 oz/A for foliar or soil and 15-750 ml. per 100 lbs of seed. Those skilled in the art would be aware that addition of a small quantity of oil and/or surfactant, preferably less than 5 wt. %, to the aqueous solution sprayed on the foliage will improve the adherence of the reaction product to the leaves and the uptake of the reaction product by the plant. Suitable oils include both saturated and unsaturated oils, alcohols, esters and other compounds having both hydrophobic and hydrophilic functional groups. Exemplary oils comprise the vegetable oils and include sunflower oil and soybean oil. Exemplary biologically acceptable surfactants include the organic polyphosphates and ethoxylated nonylphenols. Again, those skilled in the art can determine appropriate concentrations for each desired use. However, aqueous solutions having the foregoing concentrations are believed to be generally appropriate. These solutions should be applied at a rate sufficient to provide about 1-100 grams of reaction product, non-metal, metalloid and metal containing complexes per acre.

### Diacyl or Diaryl Urea

As described in U.S. Pat. No. 6,040,273, the contents of which are expressly incorporated herein by reference, the preferred diacyl or diaryl urea of the present invention are the reaction products of a carboxylic acid and a urea having the formula

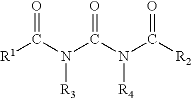

where R₁, R₂, R₃ and R₄ are the same or different and are selected from the group consisting of hydrogen, substituted and unsubstituted alkyl, allyl, vinyl and alkoxyl groups having from 1-6 carbon atoms, substituted and unsubstituted phenyl groups and the halides. Preferably, the reaction product of the present invention is N,N′-diformylurea or N,N′-diacetylurea. In one embodiment, these reaction products are prepared by reacting a carboxylic acid having the formula RCOOH where R is selected from the group consisting of hydrogen, substituted and unsubstituted alkyl, allyl₁ vinyl and alkoxyl groups having from 1-6 carbon atoms, substituted and unsubstituted phenyl groups and the halides. Exemplary acids include formic acid, acetic acid, propionic acid, butyric acid, valeric acid, caproic acid, heptanoic acid, and citric acid. Preferably R is selected from the group consisting of hydrogen and unsubstituted alkyl groups having from 1-3 carbon atoms. The presently most preferred acids are formic or acetic acid. These carboxylic acids are reacted with a substituted or unsubstituted urea having the formula (NHR′)₂ CO where each R′ is the same or different and is selected from the group consisting of hydrogen, substituted and unsubstituted alkyl groups having from 1-6 carbon atoms, substituted and unsubstituted alkoxyl groups having from 1-6 carbon atoms, substituted and unsubstituted phenyl groups and the halides. Unsubstituted urea is the presently most preferred reactant. In its most preferred embodiment, the present invention comprises the reaction product of urea and formic acid, i.e., N,N′-diformylurea, having the following formula

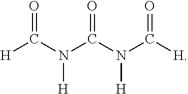

Furthermore, the agricultural formula may include diaryl ureas including, but not limited to, forchlorfenuron having the general formula:

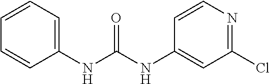

It has been found that the reaction will proceed throughout a wide range of temperatures, e.g., from about 10° C. to about 140° C., restricted only by the boiling points of the reactants and products. While heat may be added by any conventional means to speed the rate of these reactions, it has been found that the methods of the present invention may conveniently be performed in a temperature range from about 15° C. to about 40° C., preferably at room temperature, i.e., from about 20° C. to about 30° C. These reactions appear to be slightly exothermic. The reaction of formic acid and urea to form diformylurea proceeds to completion within 24 hours at room temperature. It is preferred that the reaction mixture be stirred until clear and then permitted to remain quiescent until crystals of the reaction product have formed, It is believed that the reactions proceed by the elimination of two water molecules. The reaction of urea and formic acid proceeds as follows: H₂NCONH₂+2RCOOH→RCONHCONHCOR+2H₂O. In this reaction, formic acid reacts with one hydrogen on each of the urea nitrogens to produce N,N′-diformylurea, Accordingly, it is preferred that the reaction mixture comprise about 2 moles of carboxylic acid for each mole of urea.

### Plant Growth Regulators/Phytohormones

While the at least one plant growth regulators (PGRs) provided in the synergistic agricultural formula may be any effective plant hormones, the phytohormone is typically selected from ethylene, auxins, cytokinins, gibberellins, abscisic acid, brassinosteroids, jasmonates, salicylic acids, peptides, polyamines, nitric oxide, strigolactones, precursors, derivatives and mixtures thereof. In a preferred embodiment, the synergistic agricultural formula only includes PGRs selected from ethylene, auxins, cytokinins, gibberellins, abscisic acid, brassinosteroids, jasmonates, salicylic acids, peptides, polyamines, nitric oxide, strigolactones, precursors, derivatives and mixtures thereof

The auxin is preferably selected from the group consisting of the natural auxins, synthetic auxins, auxin metabolites, auxin precursors, auxin derivatives and mixtures thereof. The preferred auxin is a natural auxin, most preferably indole-3-acetic acid. The presently preferred synthetic auxin is indole-3-butyric acid (IBA). Other exemplary synthetic auxins which may be employed in the present invention include indole 3-propionic acid, indole-3-butyric acid, phenylacetic acid, naphthalene acetic acid (NAA), 2,4-dichlorophenoxy acetic acid, 4-chloroindole-3-acetic acid, 2,4,5- trichlorophenoxy acetic acid, 2-methyl-4-chlorophenoxy acetic acid, 2,3,6- trichlorobenzoic acid, 2,4,6-trichlorobenzoic acid, 4-amino-3,4,5-trichloropicolinic acid and mixtures thereof.

The cytokinin is preferably selected from one or more of the following: zeatin, various forms of zeatin, N6-benzyl adenine, N6-(delta-2-isopentyl) adenine, 1,3-diphenyl urea, thidiazuron, CPPU (forchlorfenuron), kinetin or other chemical formulations with cytokinin activity. The preferred cytokinin is kinetin.

The gibberellin is preferably selected from one or more of the following: GA₁, GA₂, GA₃, GA₄, GA₅, GA₆, GA₇, GA₈, GA₉, GA₁₀, GA₁₁, GA₁₂, GA₁₃, GA₁₄, GA₁₅, GA₁₆, GA₁₇, GA₁₈, GA₁₉, GA₂₀, GA₂₁, GA₂₂, GA₂₃, GA₂₄, GA₂₅, GA₂₆, GA₂₇, GA₂₈, GA₂₉, GA₃₀, GA₃₁, GA₃₂, GA₃₃, GA₃₄, GA₃₅, GA₃₆, GA₃₇, GA₃₈, GA₃₉, GA₄₀, GA₄₁, GA₄₂, GA₄₃, GA₄₄, GA₄₅, GA₄₆, GA₄₇, GA₄₈, GA₄₉, GA₅₀, GA₅₁, GA₅₂, GA₅₃, GA₅₄, GA₅₅, GA₅₆, GA₅₇, GA₅₈, GA₅₉, GA₆₀, GA₆₁, GA₆₂, GA₆₃, GA₆₄, GA₆₅, GA₆₆, GA₆₇, GA₆₈, GA₆₉, GA₇₀, GA₇₁, GA₇₂, GA₇₃, GA₇₄, GA₇₅, GA₇₆, GA₇₇, GA₇₈, GA₇₉, GA₈₀, GA₈₁, GA₈₂, GA₈₃, GA₈₄, GA₈₅, GA₈₆, GA₈₇, GA₈₈, GA₈₉, GA₉₀, GA₉₁, GA₉₂, GA₉₃, GA₉₄, GA₉₅, GA₉₆, GA₉₇, GA₉₈, GA₉₉, GA₁₀₀, GA₁₀₁, GA₁₀₂, GA₁₀₃, GA₁₀₄, GA₁₀₅, GA₁₀₆, GA₁₀₇, GA₁₀₈, GA₁₀₉, GA₁₁₀, GA₁₁₁, GA₁₁₂, GA₁₁₃, GA₁₁₄, GA₁₁₅, GA₁₁₆, GA₁₁₇, GA₁₁₈, GA₁₁₉, GA₁₂₀, GA₁₂₁, GA₁₂₂, GA₁₂₃, GA₁₂₄, GA₁₂₅, and/or GA₁₂₆. The preferred gibberellin is the gibberellic acid, GA₃.

The auxins, preferably indole-3-butyric acid (IBA) and indole-3-acetic acid (IAA), are present in the synergistic agricultural formula in an amount such that the auxin is between about 0.0001 to 10 wt. %, preferably between about 0.0005 to about 5 wt. %, preferably between 0.0005 to about 2 wt. %, preferably between 0.0005 to about 1 wt. %, preferably between 0.0005 to about 0.5 wt. %, and preferably between about 0.0005 to about 0.05 wt. % of the synergistic agricultural formula.

The gibberellin, preferably gibberellic acid (GA₃), are present in the synergistic agricultural formula in an amount such that the gibberellin is between about 0.0001 to 20 wt. %, preferably between about 0.0001 to 15 wt. %, preferably between about 0.0001 to 7.5 wt. %, preferably between about 0.0005 to about 5 wt. %, preferably between about 0.0005 to about 1 wt. %, preferably between about 0.0005 to about 0.11 wt. %, preferably between about 0.0005 to about 0.07 wt. %, and preferably between about 0.0005 to about 0.05 wt. % of the synergistic agricultural formula.

The cytokinin, preferably kinetin, are present in the synergistic agricultural formula in an amount such that the cytokinin is between about 0.0003 to 0.3 wt. %, preferably between 0.0009 to 0.15 wt. %, preferably between about 0.00015 to 0.15 wt. %, and most preferably between about 0.001 to 0.05 wt. % of the synergistic agricultural formula.

As provided in International Publication WO 2012068473, the contents of which are expressly incorporated herein by reference, in a preferred embodiment of the present invention, the plant growth regulator are included as a PGR mixture of only two plant hormones—cytokinin and gibberellin. When used together, the ratio of the plant growth regulators, cytokinin and gibberellin, preferably ranges from 1:10 to 1:300 and more preferably from 1:20 to 1:40. A ratio of approximately 1:30 is most preferable. Nonetheless, to obtain the best results, the absolute amount of the cytokinins and gibberellins must vary proportionally to the volume/ weight of the treated plants and their fruit.

Additionally, in a preferred embodiment of the present invention, the plant growth regulator may include a PGR mixture of only the following two phytohormones: cytokinin and auxin. When used together, the ratio of the plant growth regulators, cytokinin and auxin, preferably ranges from 1:10 to 1:300 and more preferably from 1:20 to 1:40. A ratio of approximately 1:30 is most preferable. Nonetheless, to obtain the best results, the absolute amount of the cytokinins and gibberellins must vary proportionally to the volume/ weight of the treated plants and their fruit.

Additionally, in a preferred embodiment of the present invention, the plant growth regulator may include a PGR mixture of only three plant hormones—cytokinin, gibberellin, and auxin. In a preferred mixture, the cytokinin is kinetin, the gibberellin is GA₃, and the auxin is IBA. When used together, the amount of kinetin is preferably 4-6 times, and more preferably 2-3 times more than the amount of gibberellic acid and the amount of IBA is preferably 1-1.5 times more than the amount of gibberellic acid. The synergistic agricultural formula may preferably include: a) 0.2-0.0005 wt. %, more preferably 0.10-0.0009 wt. % kinetin; b) 0.1-0.0003 wt. %, more preferably 0.05-0.0005 wt. % GA₃;and c) 0.1-0.003 wt. %, more preferably 0.05-0.0005 wt. % IBA as the only PGRs present in the synergistic agricultural formula.

### EXAMPLES

### Maximization of Canola Yield

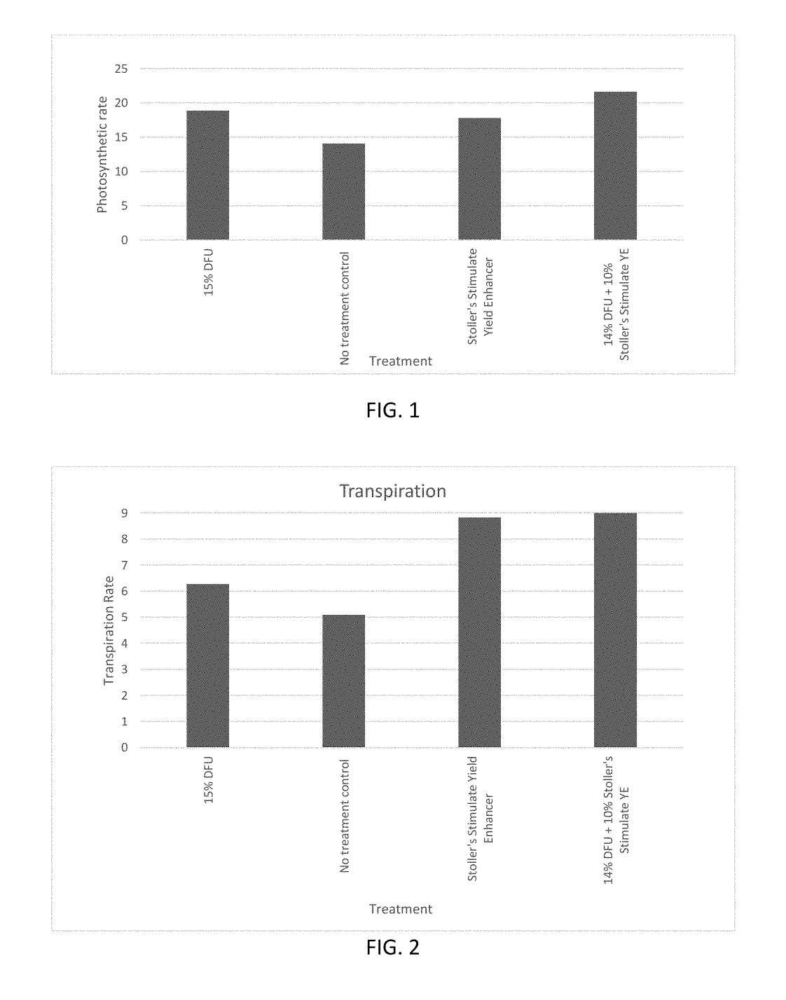

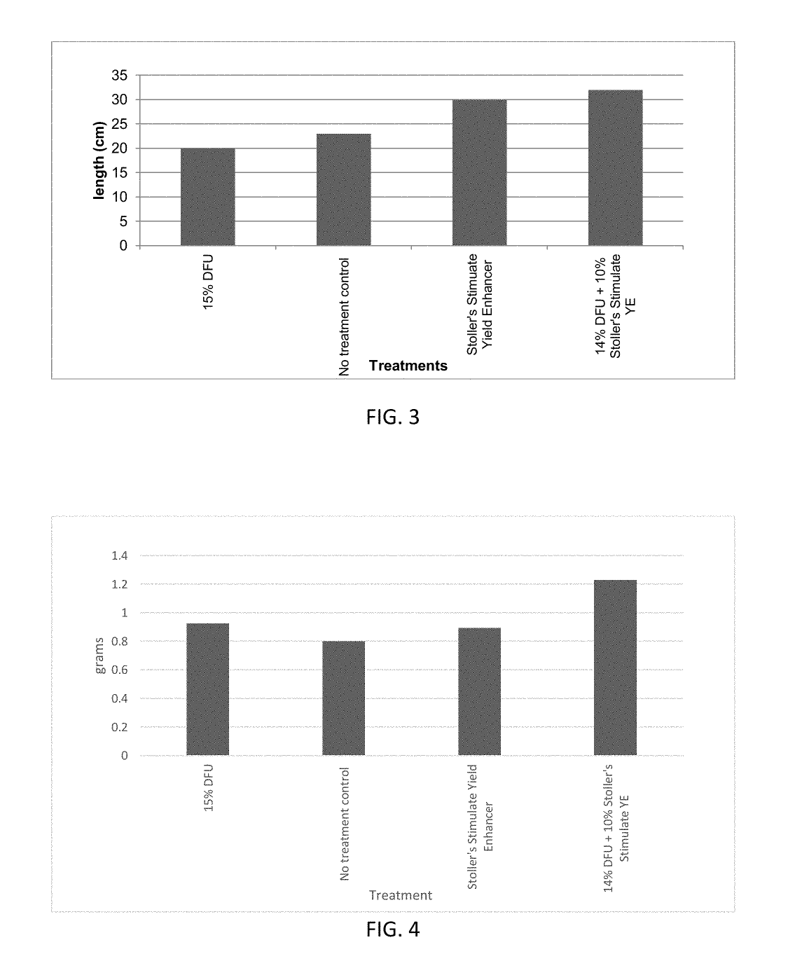

As those skilled in the art may attest, increased plant productivity leads to increased yield. A diformylurea formulation mitigates the effect of stress ethylene by mitigating stress. Stoller's STIMULATE YE plant growth regulator mix (a solution of 0.009 wt. % cytokinins, 0.005 wt. % gibberellins, and 0.005 wt. % auxins) supports early season growth and development across a wide range of crops, including corn. As seen in FIGS. 1-4, a synergistic agricultural formula in accordance with the present invention including 14 wt. % DFU and 10 wt. % of Stollers STIMULATE YE Plant Growth Regulator Mix applied at a Pint/Acre compared to each individual component applied at a Pint/Acre was found to increase photosynthesis, respiration, root length, and biomass significantly when compared to each individual component applied at a Pint/Acre alone.

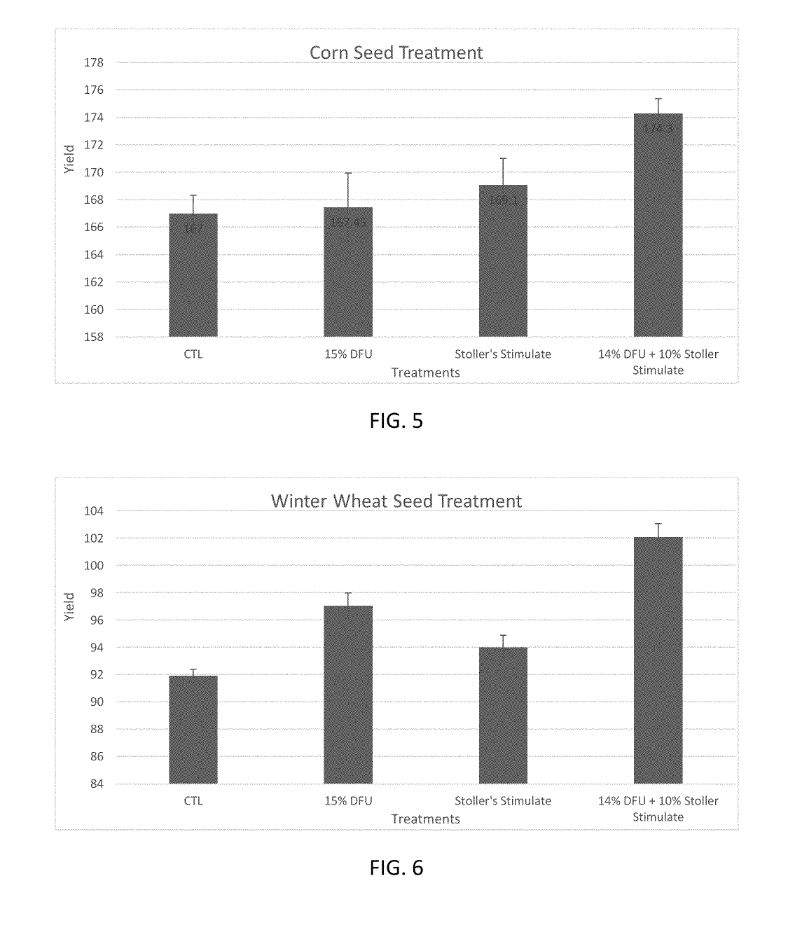

As seen in FIG. 5, a synergistic agricultural formula in accordance with the present invention including 14 wt. % DFU and 10 wt. % of Stollers STIMULATE YE Plant Growth Regulator Mix applied at a Pint/Acre compared to each individual component applied at a Pint/Acre was found to increase yield when applied as a seed treatment for corn. The statistical data for this analysis is provided as follows:

Statistical Data for FIG. 5:

| Treatment | p Vs Control | p Vs Combination |
|---|---|---|
| 15% DFU | 0.8782 | 0.0442 |
| Stoller Stimulate YE | 0.4015 | 0.0548 |
| Combination | 0.0052 | |

As seen in FIG. 6, a synergistic agricultural formula in accordance with the present invention including 14 wt. % DFU and 10 wt. % of Stoller's STIMULATE YE Plant Growth Regulator Mix applied at a Pint/Acre compared to each individual component applied at a Pint/Acre was found to increase yield when applied as a seed treatment for winter wheat. The statistical data for this analysis is provided as follows:

Statistical Data for FIG. 6:

| Treatment | p Vs Control | p Vs Combination |
|---|---|---|
| 15% DFU | 0.0026 | 0.0089 |
| Stoller Stimulate YE | 0.0852 | 0.0008 |
| Combination | 7E−5 | |

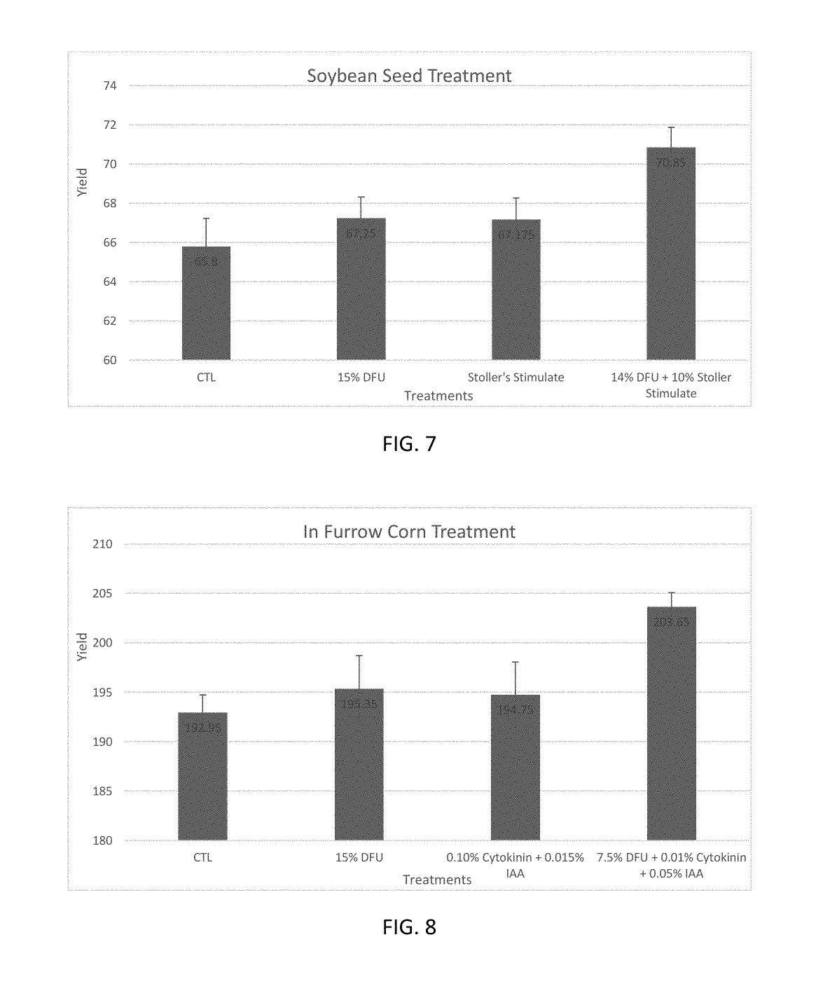

As seen in FIG. 7, a synergistic agricultural formula in accordance with the present invention including 14 wt. % DFU and 10 wt. % of Stoller's STIMULATE YE Plant Growth Regulator Mix applied at a Pint/Acre compared to each individual component applied at a Pint/Acre was found to increase yield when applied as a seed treatment for soybean. The statistical data for this analysis is provided as follows:

Statistical Data for FIG. 7:

| Treatment | p Vs Control | p Vs Combination |
|---|---|---|
| 15% DFU | 0.4492 | 0.052 |
| Stoller Stimulate YE | 0.4741 | 0.0498 |
| Combination | 0.0288 | |

As seen in FIG. 8, a synergistic agricultural formula in accordance with the present invention including 7.5 wt. % DFU, 0.01 wt. % cytokinin, and 0.05 wt. % indole-3-acetic acid (IAA) applied at a Pint/Acre compared to each individual component applied at a Pint/Acre was found to increase yield when applied as an in furrow treatment for corn. The statistical data for this analysis is provided as follows:

Statistical Data for FIG. 8

| Treatment | p Vs Control | p Vs Combination |
|---|---|---|
| 15% DFU | 0.5485 | 0.0622 |
| 0.10% Cyt + 0.015% IAA | 0.6478 | 0.0481 |
| Combination | 0.0031 | |

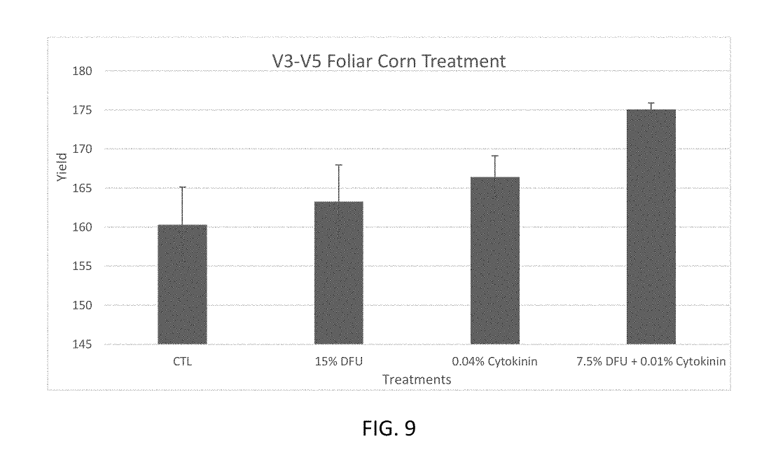

As seen in FIG. 9, a synergistic agricultural formula in accordance with the present invention including 7.5 wt. % DFU and 0.01 wt. % cytokinin applied at a Pint/Acre compared to each individual component applied at a Pint/Acre was found to increase yield when applied as an V3-V5 foliar corn treatment. The statistical data for this analysis is provided as follows:

Statistical Data for FIG. 9:

| Treatment | p Vs Control | p Vs Combination |
|---|---|---|
| 15% DFU | 0.6829 | 0.0677 |
| 0.04% Cytokinin | 0.3266 | 0.0368 |
| Combination | 0.0382 | |

Although the present invention has been disclosed in terms of a preferred embodiment, it will be understood that numerous additional modifications and variations could be made thereto without departing from the scope of the invention as defined by the following claims:

We claim:

1. An agricultural formula comprising 30 to 0.1% of at least one diacyl or diaryl urea and 0.001 to 99.9 wt % of at least one plant growth regulator.

2. The agricultural formula of claim 1, wherein said at least one diacyl or diaryl urea is only at least one diacyl urea.

3. The agricultural formula of claim 1, wherein said at least one diacyl or diaryl urea is only diformyl urea.

4. The agricultural formula of claim 1, wherein said formula only includes plant growth regulators selected from the group consisting of ethylene, auxins, cytokinins, gibberellins, abscisic acid, brassinosteroids, jasmonates, salicylic acids, peptides, polyamines, nitric oxide, strigolactones, precursors, derivatives and mixtures thereof.

5. The agricultural formula of claim 4, wherein said formula only includes plant growth regulators selected from the group consisting of auxins, cytokinins, and gibberellins.

6. The agricultural formula of claim 5, wherein said formula only includes plant growth regulators selected from the group consisting of cytokinins and gibberellins.

7. The agricultural formula of claims 5, wherein said formula only includes plant growth regulators selected from the group consisting of cytokinins and auxins.

8. The agricultural formula of claim 1, wherein said at least one diacyl or diaryl urea and said at least one plant growth regulator are the only agriculturally active ingredients.

9. The agricultural formula of claim 1 comprising 20 to 0.1 wt. % of at least one diacyl or diaryl urea and 0.001 to 5 wt. % of at least one plant growth regulator.

10. The agricultural formula of claim 1 comprising 20 to 0.1 wt. % of at least one diacyl or diaryl urea and 0.001 to 1 wt. % of at least one plant growth regulator.

11. The agricultural formula of claim 1 comprising 20 to 0.1 wt. % of at least one diacyl or diaryl urea and 0.001 to 0.1 wt. % of at least one plant growth regulator.

12. The agricultural formula of claim 1 comprising 15 to 10 wt. % of at least one diacyl or diaryl urea and 0.001 to 1 wt. % of at least one plant growth regulator.

13. The agricultural formula of claim 1, wherein said formula only includes plant growth regulators selected from the group consisting of indole-3-butyric acid, indole-3-acetic acid, gibberellic acid, and kinetin.

14. The agricultural formula of claim 13, wherein said formula includes 0.2-0.0005 wt. % kinetin.

15. The agricultural formula of claim 13, wherein said formula includes 0.1-0.0003 wt. % gibberellic acid.

16. The agricultural formula of claim 13, wherein said formula includes 0.1-0.0003 wt. % indole-3-butyric acid or indole-3-acetic acid.

17. The agricultural formula of claim 13, wherein said formula includes 0.2-0.0005 wt. % kinetin, 0.1-0.0003 wt. % gibberellic acid, and 0.1-0.0003 wt. % indole-3-butyric acid or indole-3-acetic acid.

18. An agricultural formula consisting essentially of,
at least one diacyl or diaryl urea,
at least one plant growth regulator,
water, and
less than 5 wt. % oil and surfactants,
wherein said at least one diacyl or diaryl urea and said at least one plant growth regulator are the only agriculturally active ingredients.

19. The agricultural formula of claim 18, wherein said at least one diacyl or diaryl urea is only diformylurea.

20. The agricultural formula of claim 19, wherein said formula only includes plant growth regulators selected from the group consisting of indole-3-butyric acid, indole-3-acetic acid, gibberellic acid, and kinetin.
